(19) United States
(12) Patent Application Publication
(10) Pub. No.: US 2021/0334739 A1
(43) Pub. Date: Oct. 28, 2021

(54) STORAGE AND INVENTORY MONITORING SYSTEMS, DEVICES, AND METHODS

(71) Applicants: Connor J. O'Neil, Madison, WI (US); Nicholas J. Grundl, Oakland, CA (US); Katherine C. Grundl, Minneapolis, MN (US)

(72) Inventors: Connor J. O'Neil, Madison, WI (US); Nicholas J. Grundl, Oakland, CA (US); Katherine C. Grundl, Minneapolis, MN (US)

(21) Appl. No.: 16/860,766

(22) Filed: Apr. 28, 2020

(51) Int. Cl. G06Q 10/08; H04W 4/35; G01G 19/414

(52) U.S. Cl. CPC G06Q 10/087; G01G 19/4144; H04W 4/35

(57) ABSTRACT

Inventory monitoring systems can include one or more load cells, pressure sensors, and/or force sensors to detect objects on a surface in a storage unit, a communication interface, and one or more processors operably coupled to the one or more load cells and the communication interface. The one or more processors can be configured to receive measurements from the one or more load cells. The inventory monitoring system may identify an object using regression analysis and statistical inference techniques based on the measurements to generate an inventory of items stored in the storage unit, and provide an autonomous, real-time tracking of the inventory to a user via the communication interface.

### TECHNICAL FIELD

The present disclosure relates generally to inventory monitoring. More particularly, some embodiments relate to automatically classifying and maintaining an inventory.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A illustrates a top planar view of a single load cell measuring a load on a surface, according to one embodiment.

FIG. 1B illustrates a top planar view of a surface with a set of four load cells (a first load cell, second load cell, third load cell, fourth load cell) measuring a load on the surface, according to one embodiment.

FIG. 2 illustrates a cross-sectional view of a refrigerator monitored by an inventory system, according to one embodiment of the present disclosure.

FIG. 3 illustrates a network block diagram of an inventory system, according to one embodiment.

FIG. 4 is a flow diagram illustrating a data processing method of an inventory system, according to one embodiment.

FIG. 5 is a flow diagram illustrating a method for encoding a state space representing an inventory, according to one embodiment.

FIG. 6 illustrates a chart showing dates when various fruits and vegetables are in season according to one embodiment.

FIG. 7A illustrates a graph of a first event being detected according to one embodiment.

FIG. 7B illustrates a graph of a second event being detected according to one embodiment.

FIG. 8 is a block diagram of an inventory system hub according to one embodiment.

### DETAILED DESCRIPTION

Manually tracking items currently in an inventory can be time-consuming. Embodiments herein provide systems, methods, and apparatuses for automatically identifying and tracking inventory to alleviate the time-consuming process of manual inventory tracking. In some embodiments, an inventory system can measure a load (e.g., weight, mass of a load, location, contact surface area), and can use that information to determine the load's composition.

For example, the inventory system may be used to identify and track food on a refrigerator shelf. The inventory system may use the weight of the food items and regression analysis techniques to know the state of a load on the shelf. The state of the load on the shelf in this example would include the types of food on the shelf and the amount of each food on the shelf. While this example and many examples below specifically relate to refrigerator food storage inventory tracking, the inventory system may be used in a variety of settings including a food pantry, pharmaceutical shelving, money vault, and grocery shelving.

The inventory system may include one or more load cells to detect objects on a surface in a storage unit. The inventory system may further include a communication interface. One or more processors of the inventory system may be operably coupled to the one or more load cells and the communication interface. The processors may receive measurements from the one or more load cells, and identify one or more objects using regression analysis based on the measurements. The processors may also generate an inventory based on the identification and provide the inventory to a user device.

A load cell may be used to measure weight, mass, and spatial data of an object. For example, measurements of an object may include mass, weight, location on a surface, the item's contact surface size, which surface the item is on (e.g., drawer, shelf, in the door or in the main compartment) and/or whether the surface is in the fridge section or the freezer section. In some embodiments, a subset of these measured data points may be used. Thus, as used herein, measure and measurement may refer to weight, mass, and/or spatial data of an object.

As used herein a state space includes inventory arrangements within the storage units. The state space may represent a possible inventory arrangement or the actual current inventory arrangement.

It will be readily understood that the components of the embodiments as generally described below and illustrated in the Figures herein could be arranged and designed in a wide variety of different configurations. For instance, the steps of a method do not necessarily need to be executed in any specific order, or even sequentially, nor do the steps need to be executed only once. Thus, the following more detailed description of various embodiments, as described below and represented in the Figures, is not intended to limit the scope of the disclosure, but is merely representative of various embodiments. While the various aspects of the embodiments are presented in the drawings, the drawings are not necessarily drawn to scale unless specifically indicated.

Embodiments and implementations of systems and methods described herein may include various steps, which may be embodied in machine-executable instructions to be executed by a computer system. A computer system may include one or more general-purpose or special-purpose computers (or other electronic devices). The computer system may include hardware components that include specific logic for performing the steps or may include a combination of hardware, software, and/or firmware.

Embodiments may be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables; telephone lines; radio waves; satellites; microwave relays; modulated AC power lines; physical media transfer; and/or other data transmission “wires” known to those of skill in the art. The network may encompass smaller networks and/or be connectable to other networks through a gateway or similar mechanism.

Each computer system includes one or more processors and/or memory; computer systems may also include various input devices and/or output devices. The processor may include a general-purpose device, such as an Intel®, AMD®, or other “off-the-shelf” microprocessor. The processor may include a special-purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touchscreen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, RAM, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, PHP, .Net, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Aspects of certain embodiments may be implemented as software modules or components. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types. A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media.

Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network. According to one embodiment, a database management system (DBMS) allows users to interact with one or more databases and provides access to the data contained in the databases.

The phrase “coupled to” is broad enough to refer to any suitable coupling or other form of interaction between two or more entities. Two components may be coupled to each other even though they are not in direct contact with each other. For example, two components may be coupled to one another through an intermediate component. The phrases “attached to” or “attached directly to” refer to interaction between two or more entities that are in direct contact with each other and/or are separated from each other only by a fastener of any suitable variety (e.g., an adhesive).

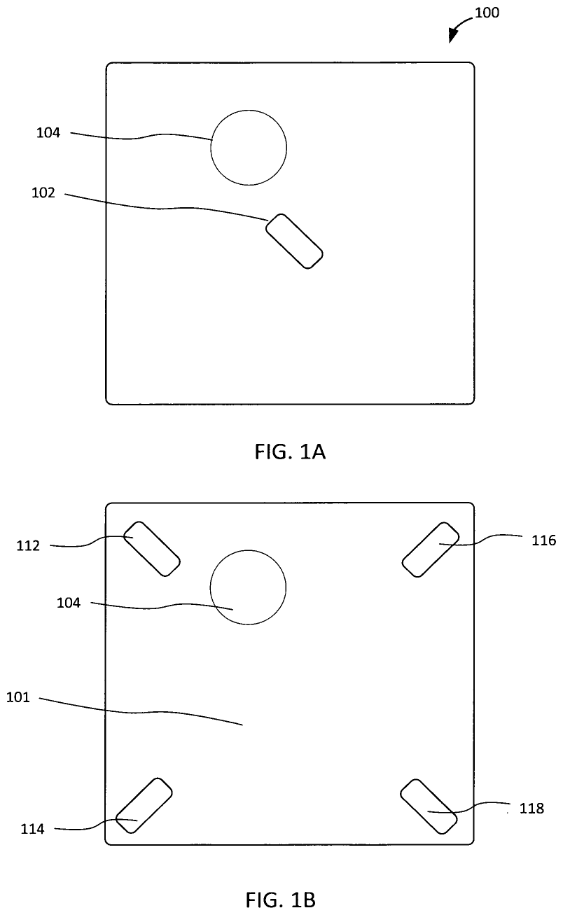

FIG. 1A illustrates a top planar view of a single load cell 102 measuring a load on a surface 100 according to one embodiment. In some embodiments, one or more transducer mats can be used as an alternative or in addition to the load cell 102.

The load cell 102 may be used to detect objects on the surface 100. For example, the load cell 102 may weigh an orange 104 placed on the surface 100. In some embodiments, the load cell 102 may also determine a location of the orange 104 on the shelf. The weight of the object and the location of the object on the surface 100 may be used by an inventory system to help identify the object as the orange 104.

The load cell 102 may be incorporated onto the surface 100 in a variety of ways. For example, the load cell 102 can be built within the shelf or beneath the shelf, and with load cell designs that range from planar, beam, S-type, etc. In some embodiments, the load cell 102 can be attached to a pre-existing shelf in a storage unit to retrofit the storage unit.

The surface 100 may be in a storage unit. A storage unit may be anything capable of storing or holding objects including for example a refrigerator, a freezer, shelving, a pantry, and a money vault. The type of storage unit where the surface 100 is located may be used by an inventory system to help identify an object on the surface.

FIG. 1B illustrates a top planar view of a surface 101 with a set of four load cells (a first load cell 112, second load cell 114, third load cell 116, fourth load cell 118) measuring a load on the surface 101, according to one embodiment. More than one load cell may provide more accurate location measurements and weight measurements of the load (again an orange 104 in FIG. 1B). In some embodiments, an inventory system may use a different number of load cells based on the size of the surface 102.

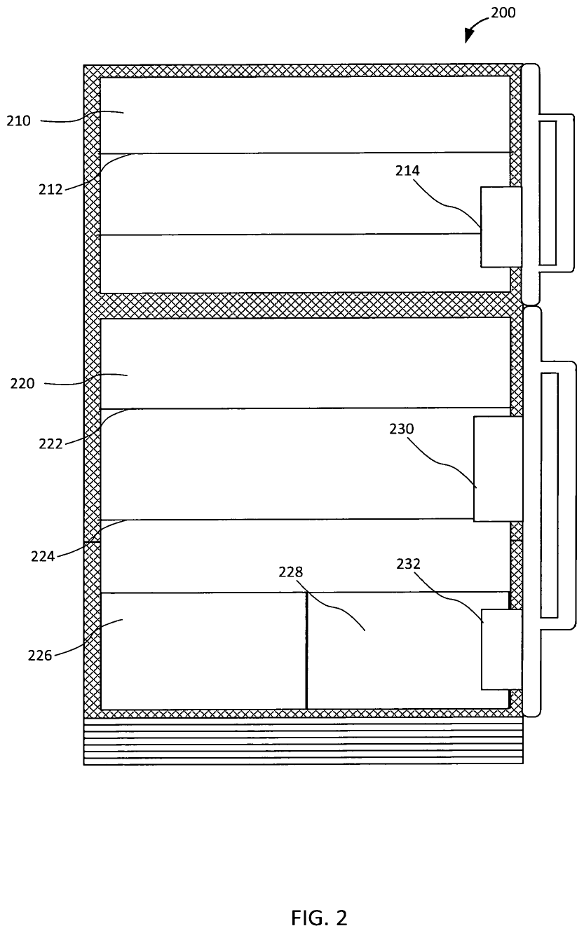

FIG. 2 illustrates a cross-sectional view of a refrigerator 200 monitored by an inventory system, according to one embodiment. Load cells may be disposed on one or more shelfs (e.g., 212, 214, 222, 224, 230, 232), and/or one or more drawers (e.g., 226, 228) of the refrigerator 200. The load on each surface of each shelf of the refrigerator 200 may be measured by one or more load sensors to determine spatial measurements and weight or mass measurements. The inventory system may be able to identify a food item based on a subset of variables that include weight, location on a surface, the item's contact surface size, which surface the item is on (e.g., drawer, shelf, in the door or in the main compartment), statistics about the item's previous locations, and/or whether the surface is in the fridge section or the freezer section. For example, the inventory system may identify an apple by its multiple contact surfaces, and an orange because of its single contact surface. As another example, the inventory system may determine that an object is an orange rather than a potato at least because the inventory system determines the object is in a drawer statistically associated with fruit. In some embodiments, the inventory system can identify multiple different items on one surface using the methods described below.

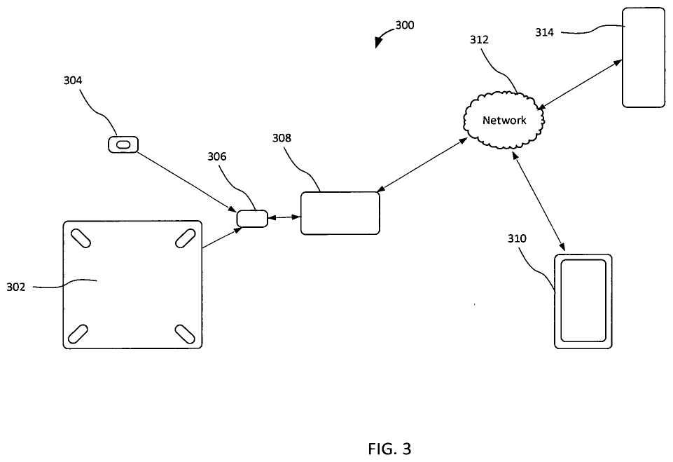

FIG. 3 illustrates a network block diagram of an inventory system 300, according to one embodiment. The illustrated embodiment includes a shelf 302 with load cells, a light sensor 304, a data logger 306, and a hub 308.

The shelf 302 includes one or more load cells or other transducers to weigh items and determine spatial information of an item on a surface of the shelf 302. Output of load cells is in ratio of voltages, and can be used to sense changes at a resolution of tenths of a gram or less for a basic, off-the-shelf load cell. The signal may be amplified, potentially filtered (i.e., low-pass filter to smooth faster time-scale measurements), and/or converted from analog to digital. Amplification and filtering could be handled digitally or analog. Measurement accuracy can be improved and spatial data can be provided by using multiple cells. By using multiple cells, multiple cell arrangements, and/or multiple types of cells (e.g., force-sensing resistors, force-sensing capacitors, strain gauge devices) spatial data and measurement accuracy can be improved. The one or more load cells may transmit the measurement data (e.g., weight data, spatial data) to the data logger 306. The transmission may be over a wired or wireless connection.

The data logger 306 can be a standalone, integrated, remote, or local computing device. The data logger 306 can receive the electrical output from sensors/sensor processing hardware. The data logger 306 may receive data over a wireless protocol such as Wi-Fi. For example, wireless interfacing may be used within a storage unit. In some embodiments, the data logger 306 and the hub 308 may be the same device. The data logger 306 may transmit recorded measurements to the hub 308.

The inventory system 300 may be configured to selectively measure and/or record data. In some embodiments, the load cells only measure when an event occurs. In some embodiments, the data logger 306 only records data when an event occurs. An event refers to a change in a state space corresponding to the inventory in the storage unit where the load cells are located. A state space is a of representation of possible inventory arrangements. A change in the state space refers to a change in measurement data that causes change to the possible inventory arrangements. The event may cause measurements to initiate/conclude. In some embodiments, an event can be the light sensor 304 detecting light above a certain threshold, or load cells recording measurements above a certain threshold. An event can trigger measurement or recording of load cell data. Light sensor and/or load cell interactions can be performed by a micro-controller or analog arrangement.

The hub 308 may receive the recorded measurement and/or spatial data from the data logger 306. The hub 308 may be a computer or some other processing logic circuitry. The hub 308 may be local or remote from the data logger 306. The interface between the data logger 306 and the hub 308 may be wired or wireless. The hub 308 may include a processor configured to receive measurements from the one or more load cells, and identify one or more objects using regression analysis based on the weight data and the spatial data, in combination with metadata, such as time of day, time of season, or geographic availability of product. The hub 308 may generate an inventory of items stored in a storage unit, the inventory including the identified first object and the second object, and provide the inventory to a personal electronic device (PED) 310 via a network 312. The spatial data may include a location of objects, contact surface size, and contact surface shape associated with each object.

Weight measurements and spatial data measurements can be stored and organized in tabular data, such as a .csv file on a memory device of the hub 308, or on a distributed storage provided by a network 312. For example, the spatial data measurements can be stored on SQL databases, or noSQL databases. The data can be recorded along with relevant extra variables such as time of day, season, weather, shelf location. Another relevant variable could be how quickly from the time an object first appears in the storage unit until it is removed and the rate at which the object is consumed (i.e., how many days, weeks, months it sits on the shelf and how quickly it's mass is decreased). For example, grapes may be partially removed from a fridge, and the rate of removal may be incorporated as a relevant variable. For example, the rate of change may be discrete such as a single ice cube being removed from a tray per event, or the rate may be continuous such as milk being poured from a container. At any time, a measurement and its extra variables are evaluated by regression analysis to provide the shelf's “state.”

The hub 308 can compare a current state with previous states and usage statistics (what times do you usually eat an egg?) to predict the probability of what action took place on the shelf. In some embodiments, the system may determine the probability of what action took place and assess potential error for the states. For example, the hub 308 may use machine learning to train Bayesian models to become more certain of particular actions occurring. The hub 308 can use statistical methods (e.g., regression analysis) to determine the state. For example, classification algorithms (e.g., support vector machines, neural networks, etc.) can be adapted for the environment of the shelf 302. Classifiers are accessible in many modern programming language, but need a certain amount of re-tooling for suitability. The hub 308 may use a classification technique and/or a set of predictive statistical techniques (e.g. Kalman filtering, Bayesian inference, Hidden Markov modeling) to identify the objects.

The hub 308 can communicate through a network with the PED 310 and other third-party servers. The hub 308 may send the inventory and alerts when an item is gone or almost out to the PED 310. In some embodiments, when the hub 308 is unable to identify items on the shelf 302, the hub 308 may send a request to the PED 310 for the user to identify the object. The hub 308 may receive additional inputs from a third-party server 314.

The third-party server 314 may provide item data and/or object metadata. For example, item data related to groceries (grocery data) can include digitized receipts/records of purchase from retailers. The grocery data may also be extracted by the inventory system 300 from such receipts. For example, the grocery data may also be extracted using unique identification codes for each item (PLU numbers for “loose” products like produce, a UPC for all bar-coded options). The identification codes can contain weight information within them, or can be linked to weight data from other third-party sources. For example, a customer's digital receipt (or physical receipt if scanned) can be scraped, tabulated, and received by the hub 308 to assist in identifying objects. Object metadata may include an item's cost, its caloric and nutrient values, its culinary profile, time purchased, location purchased, etc. In one embodiment, object metadata could be initially gathered and prepared from sources such as USDA's open access database, which associates UPC codes with nutritional data.

The hub 308 may use deductive methods, regression methods, and/or supervised learning to identify different objects. For example, the hub 308 may use a deductive method for reducing possible state space of the shelf. This may be a preliminary data processing method. In some embodiments, the hub 308 can perform a deductive method by taking the raw measurements from the previous state, comparing them against the current raw measurement, and determining what possible items/actions could be involved.

The hub 308 may use regression analysis to further limit the possible states or determine a state of items on the shelf 302. The regression analysis may be based on location of the object, weight of the object, contact surface size and shape. Additional inputs that the hub 308 may use for regression analysis may come from a third-party server 314 and may include grocery data, season data, time of day, previous inventory state, food object metadata, and user eating habits.

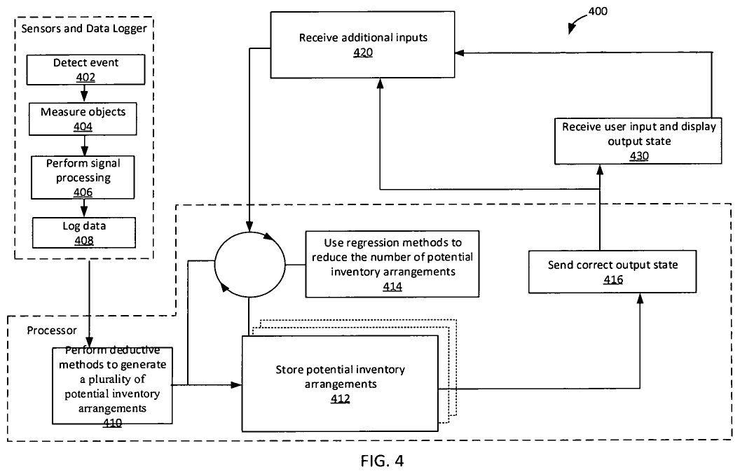

FIG. 4 is a flow diagram illustrating a data processing method 400 of an inventory system, according to one embodiment. The data processing may initiate based on a user's interaction with the inventory system. For example, the inventory system may begin processing data when the system detects an event 402, such as a new object being placed.

In some embodiments, an event detection may trigger the data processing method 400 to initiate. For example, a sensor may detect 402 an event. The event may include light detected by a light sensor, movement detected by a motion sensor, and additional weight detected on a load sensor. In some embodiments no event is needed to trigger execution of the data processing method 400; instead it may be in continuous operation.

The sensors measure 404 objects placed on a shelf of a storage unit. The measurements may include mass, weight, and spatial data. The sensors output a signal, and the inventory system performs 406 signal processing on the signal. The signal processing can include a low pass filter to reduce fluctuation in the measurements, and an amplifier to amplify the signal. The measured data may be logged 408 and sent to one or more processors as a measured state. The measured state may include the absolute digitized measurements of load cells (e.g., grams, or pounds) and the object locations. One such measured state may exist for and be correlated with each event. In other words, the measured state constitutes the measured environment of the shelf after an event.

The inventory system performs 410 deductive methods to generate a plurality of potential inventory arrangements. The deductive methods may include comparing the current measured state of the storage unit to a previous measured state of the storage unit to yield a plurality of potential inventory arrangements. For example, if an item were taken out of the storage unit, the current measured state may be compared to the previous state to determine what location and weight is different and uniquely identify the item that was taken. The inventory system may store 412 potential inventory arrangements (a consistent state space) as determined by the deductive methods. Potential inventory arrangements may be referred to as a consistent state space as they refer to different possible states of the inventory that are consistent with the current measured data.

The consistent state space may be constrained/reduced via regression methods and supervised learning. In other words, the inventory system may use these methods to reduce the number of potential inventory arrangements of the consistent state space to determine a correct output state.

For example, the inventory system may use 414 regression analysis methods to reduce the number of potential inventory arrangements. The regression analysis may include a feedback loop in which potential inventory arrangements, current measured state of the storage unit, previous measured state of the storage unit, user feedback, and additional inputs are fed into regression models to identify a correct output state or at least reduce the number of potential inventory arrangements.

For example, the inventory system may receive 420 additional inputs. The additional inputs may include grocery data (digitized receipts), season/time of day, previous output state, object metadata, and/or eating habits. The regression analysis may consider some combination of the additional inputs, the location of objects, and the weight of the objects. The regression analysis methods may be based on a relationship between a criterion variable comprising an item type and predictor variables comprising weight, location, and secondary inputs.

The regression methods may reduce the stored potential inventory arrangements. The inventory system may send 416 a correct output state to the user. The correct output state may include the most likely inventory arrangement based on the regression analysis and deductive methods.

In some embodiments, if there is more than one potential inventory arrangement after the deductive methods and the regression analysis, the inventory system may send potential inventory arrangements to the user to display the output state and receive 430 user feedback indicating the correct inventory arrangement. In some embodiments, the potential inventory arrangements may be arranged based on likelihood of correct output state to reduce the number of arrangements the user looks at before determining the correct inventory arrangement. The correct output state or the multiple possible correct output states may be sent to a user interface and reused in the regression analysis as an additional input.

The inventory system may receive 430 user input and display output state. If a single output state has been identified, the inventory system may send the output state to a display device that can display the current inventory. In some embodiments, the inventory system may utilize supervised learning based on feedback from the user input. For example, the user may select a correct output state when the inventory system fails to determine a single correct output state. As another example, the user may provide input to correct errors in an output state. This user input may then be used to correct the output state to create a new correct output state. The correct output state could be fed into the additional inputs to guide future regression analysis and help the computer understand mistakes and/or use a history of stored objects to determine a current item.

The following example uses the data processing method 400 to identify an item with continuous mass distribution (e.g., a carton of milk). In this example, the inventory system begins to implement the steps with a generic item placeholder. The inventory system uses the data processing method 400 and sends 416 a correct output state, including a milk carton on a shelf. The inventory system detects that a user removes the milk carton from the fridge, triggering an event (e.g., detect 402 event). The user affects the mass of milk (e.g., uses 5% of milk for cereal), and returns it to shelf, thereby triggering another event. Accordingly, the inventory system measures 404 the object. The inventory system performs 410 deductive methods to generate a plurality of potential inventory arrangements (i.e., state spaces). For example, the object returned could be 95% previous milk mass or a chicken breast with a mass and shelf location similar to the returned milk, resulting in two state spaces consistent with the measurement. The inventory system supplements the state space by receiving 420 additional inputs and using 414 regression methods to constrain and reduce consistent state spaces (e.g., cereal is generally eaten in the morning with milk, whereas chicken is not; milk has shelf life of ˜10 days, etc.). Using the regression methods, the inventory system may constrain the consistent state spaces to a single correct output state (i.e., 95% milk remaining in the milk carton).

In another example, the inventory system may use the data processing method 400 to determine whether an object is a grape or a cherry. The inventory system may use multiple lines-of-evidence to solve a regression problem. In some embodiments, the inventory system may use optional supervised learning. In this example, the inventory system implements the steps of the data processing method 400 yielding two potential inventory arrangements (i.e., a state space including cherries or a state space including grapes).

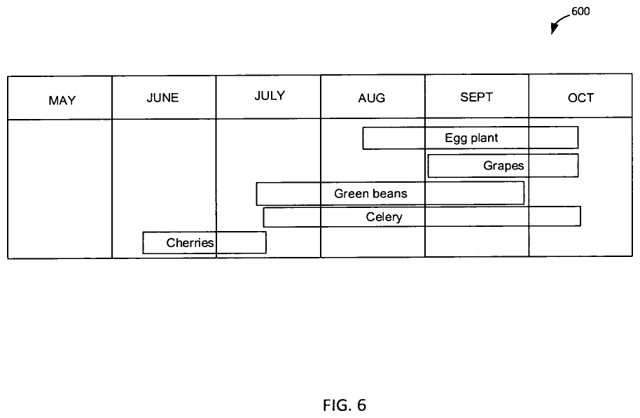

The inventory system may receive 420 additional inputs and use the additional inputs to constrain the potential inventory arrangements using 414 regression methods to reduce the number of potential inventory arrangements. For instance, the inventory management system may receive an additional input representing ripeness of grapes and cherries as a unique function of season/time of year (e.g., see FIG. 6). For cherries, ripeness may be from mid-June to mid-July, while grapes may be early September to mid-October. The inventory system may determine if the object is a cherry or a grape by comparing the ripeness data to a current date.

The system may use additional inputs for the regression methods. A second example input is eating habits of cherries and eating habits of grapes. Grapes can be consumed by the branch, whereas cherries are not. This distinction in eating habits may lead to a different measurement profile, particularly over time. In a third example the inventory system may use a user profile. If the user has not purchased grapes to date, the inventory system may determine that the inventory includes cherries.

Following use of additional inputs, if the system has not resolved a single correct output state, supervised learning is used to select between a few remaining potential inventory arrangements (i.e., consistent state spaces). As opposed to unsupervised learning, supervised learning allows for an actor or objective to train the regression. Supervised learning may allow the actor to resolve ambiguities in the state space, thus training the regression for future problems. For example the inventory system may prompt user input by sending a question asking if an object comprises cherries, or grapes. Information regarding eating habits is captured by sending the correct state as an additional input.

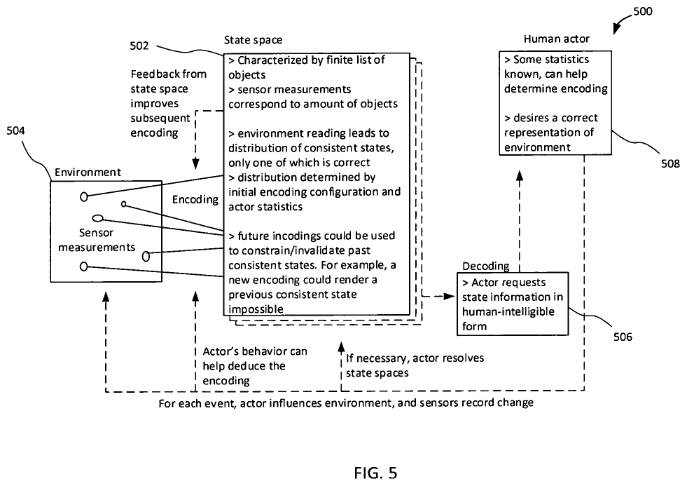

FIG. 5 illustrates a flow diagram of a method 500 for encoding a state space 502 representing an inventory, according to one embodiment. The state space 502 comprises a finite list of objects within the inventory. Encoding of the state space 502 can initiate by receiving measurements from one or more sensors 504 in an environment.

An inventory system may use the sensor measurements and the environment where the sensors 504 are located to determine one or more consistent state spaces. A consistent state space represents an inventory arrangement with objects that correspond to the number of objects measured by the sensors 504 and the weight of the objects.

When the inventory system determines multiple consistent state spaces, the inventory system may determine a statistical distribution indicating probability of each consistent state space being correct. The statistical distribution may be based on initial state encoding configuration (e.g., initial location, weight, and/or quantity of objects) and actor statistics. Actor statistics may include actor behavior, including past behavior and rate of consumption. Future encodings may be used to constrain/invalidate past consistent spaces. For example, a new encoding could render a previous consistent state impossible.

In some embodiments, an actor (e.g., user) may resolve the state space if the inventory system is unable to determine a correct state space. The inventory system may send a decoded state space 506 to a user interface 508. The decoded state space 506 may be a representation of the inventory in human-intelligible form or be instructions for a user interface to represent the inventory in human-intelligible form. The user interface 508 may display the inventory and receive user input. The user input may include a correct state space.

FIG. 6 illustrates a chart 600 showing dates when various fruits are in season. This information may be used by an inventory system as an additional input for regression analysis. For example, the inventory management system may use a current date and the seasonal ripeness information to determine if an object is a grape or a cherry.

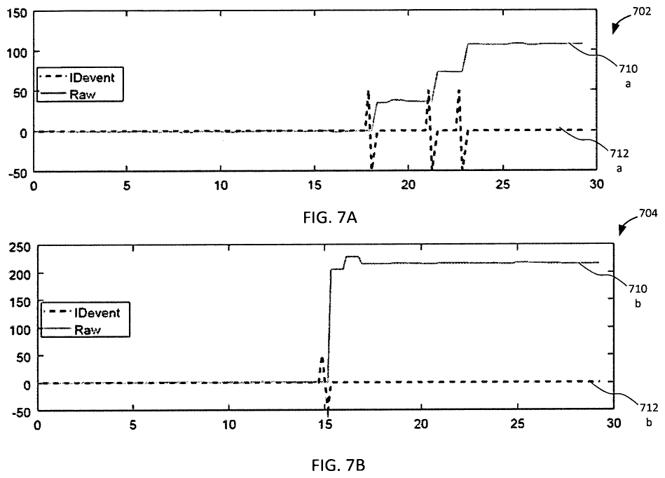

FIGS. 7A and 7B illustrate a graph 702 and 704 of events being detected, according to one embodiment. In FIGS. 7A and 7B, raw measurement values 710a and 710b of an item being placed on a sensor are recorded in grams, the y-axis. An inventory system may identify that an event occurred by taking the derivative of the raw measurement values 710a and 710b (e.g., an IDevent signal 712a and 712b). The derivative provides a spike when an object is placed on the sensor. The spike may be identified by the inventory system and, in some embodiments, cause the inventory management system to execute a method to identify the object. The number of times an event is triggered within a threshold time span may be used by the inventory system to determine the item. For example, oranges may be placed in a pile one at a time resulting in measurements similar to FIG. 7A, whereas a juice carton would cause only one spike in the IDevent signal similar to FIG. 7B.

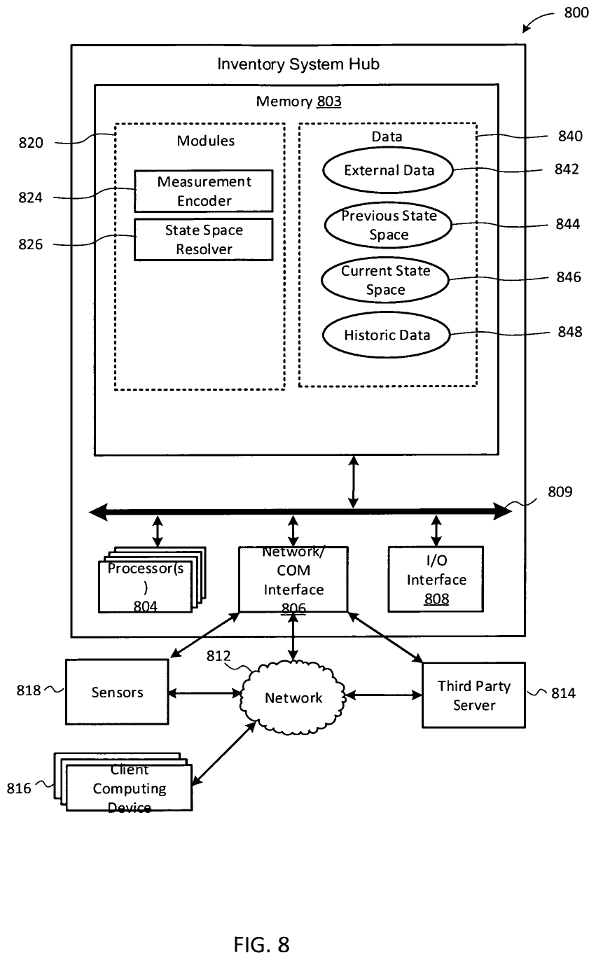

FIG. 8 is a block diagram of an inventory system hub 800 according to one embodiment. The inventory system hub 800 may be the same hub 308 illustrated in FIG. 3. The inventory system hub 800 can include a memory 803, one or more processors 804, a network interface 806, an input/output interface 808, and a system bus 809.

The one or more processors 804 may include one or more general purpose devices, such as an Intel®, AMD®, or other standard microprocessor. The one or more processors 804 may include a special purpose processing device, such as ASIC, SoC, SiP, FPGA, PAL, PLA, FPLA, PLD, or other customized or programmable device. The one or more processors 804 can perform distributed (e.g., parallel) processing to execute or otherwise implement functionalities of the presently disclosed embodiments. The one or more processors 804 may run a standard operating system and perform standard operating system functions. It is recognized that any standard operating system may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 803 may include static RAM, dynamic RAM, flash memory, one or more flip-flops, ROM, CD-ROM, DVD, disk, tape, or magnetic, optical, or other computer storage medium. The memory 803 may include a plurality of program modules 820 and program data 840. The memory 803 may be local to the inventory system hub 800, as shown, or may be distributed and/or remote relative to the inventory system hub 800.

The program modules 820 may include all or portions of other elements of the inventory system hub 800. The program modules 820 may run multiple operations concurrently or in parallel by or on the one or more processors 804. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, causes a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems and/or the like.

The program modules 820 may comprise a measurement encoder 824 and a state space resolver 826. The measurement encoder 824 receives measurements from one or more sensors 818 or a data logger and determines possible state spaces comprising one or more possible inventory arrangements of items being stored. The state space resolver 826 uses regression analysis to reduce the state spaces to a current state space 846. The state space resolver 826 may use a previous state space 844, external data 842, and historic data 848 for the regression analysis.

The memory 803 may also include the program data 840. While in the illustrated embodiment the data 840 is shown stored in the inventory system hub 800, all or a portion of the data may be stored in a separate data logger. Data generated by the inventory system hub 800, such as by the state space resolver 826 or other modules, may be stored on the memory 803, for example, as the previous state space 844 and the current state space 846. The data 840 may be organized as one or more databases. The data 840 may include the external data 842 which may include data from a third-party server 814 or a user through a client computing device 816. The data 840 may also include the historic data 848 that tracks user habits.

The input/output interface 808 may facilitate user interaction with one or more input devices and/or one or more output devices. The input device(s) may include a keyboard, mouse, touchscreen, light pen, tablet, microphone, sensor, or other hardware with accompanying firmware and/or software. The output device(s) may include a monitor or other display, printer, speech or text synthesizer, switch, signal line, or other hardware with accompanying firmware and/or software. For example, in one embodiment, the input/output interface 808 comprises a display to provide a graphical user interface illustrating the potential inventory. The input/output interface 808 can receive information from the user regarding the inventory. In some embodiments, the input/output interface 808 is a touchscreen, and the size input is received via the touchscreen.

The network interface 806 may facilitate communication with other computing devices and/or networks and/or other computing and/or communications networks. The network interface 806 may be equipped with conventional network connectivity, such as, for example, Ethernet (IEEE 1102.3), Token Ring (IEEE 1102.5), Fiber Distributed Datalink Interface (FDDI), or Asynchronous Transfer Mode (ATM). Further, the network interface 806 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 809 may facilitate communication and/or interaction between the other components of the inventory system hub 800, including the one or more processors 804, the memory 803, the input/output interface 808, and the network interface 806.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to an “embodiment” means that a particular feature, structure, or characteristic described in connection with that embodiment is included in at least one embodiment. Thus, references to embodiments throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

1. An inventory monitoring system comprising:
one or more load cells or force sensors to detect objects on a surface in a storage unit;
a communication interface;
one or more processors operably coupled to the one or more load cells and the communication interface, the one or more processors configured to:
receive measurements from the one or more load cells or force sensors, wherein the measurements include weight data and spatial data associated with a first object and a second object on the surface in the storage unit;
identify the first object and the second object using regression analysis based on the weight data and the spatial data;
generate an inventory of items stored in the storage unit, the inventory including the identified first object and the second object; and
provide the inventory to a display device via the communication interface.

2. The inventory monitoring system of claim 1, wherein the one or more processors are further configured to determine a possible inventory change event before receiving measurements.

3. The inventory monitoring system of claim 2, further comprising:
a light sensor; and
wherein the one or more processors are operably coupled to the light sensor, wherein the possible inventory change event is determined when the light sensor detects light.

4. The inventory monitoring system of claim 1, wherein the one or more processors are further configured to:
determine that a portion of the first object was removed from the storage unit; and
update the inventory with a new amount associated with the first object.

5. The inventory monitoring system of claim 4, wherein the one or more processors are further configured to send, via the communication interface, an alert to a user device when the new amount is below a target threshold.

6. The inventory monitoring system of claim 1, wherein the spatial data includes a first location associated with the first object, a second location associated with the second object, a first contact surface size and shape associated with the first object, and a second contact surface size and shape associated with the second object.

7. The inventory monitoring system of claim 1, further comprising a second set of load cells or force sensors to detect objects on a second surface in the storage unit, wherein the regression analysis is further based on which surface the first object and the second object are placed.

8. The inventory monitoring system of claim 1, wherein the regression analysis is further based on secondary inputs selected from the group consisting of grocery data, season data, time of day, previous inventory state, food object metadata, and user eating habits.

9. The inventory monitoring system of claim 1, wherein the one or more processors are further configured to:
receive user input when regression analysis results in multiple possible inventory arrangements; and
wherein the user input is used in future object identification.

10. A non-transitory computer readable medium storing instructions that, when executed by a processor, cause the processor to perform operations to:
receive measurement data from a plurality of load cells or force sensors measuring forces on surfaces in a storage unit;
determine, using the received measurement data, a first location and a first weight associated with a first item, and a second location and a second weight associated with a second item;
receive secondary inputs, wherein the secondary inputs are different from the measurement data;
identify the first item and the second item using regression analysis based on a relationship between a criterion variable comprising item type and predictor variables comprising weight, location, and secondary inputs; and
generate an inventory of items stored in the storage unit, the inventory including the identified first item and the identified second item; and
provide the inventory to a display device via the communication interface.

11. The non-transitory computer readable medium of claim 10, wherein the secondary inputs comprise grocery data.

12. The non-transitory computer readable medium of claim 11, wherein the grocery data is received from a digitized receipt.

13. The non-transitory computer readable medium of claim 10, wherein the secondary inputs comprise a current date, and wherein the regression analysis considers seasonal availability of food types.

14. The non-transitory computer readable medium of claim 10, wherein the secondary inputs comprise food type metadata.

15. The non-transitory computer readable medium of claim 10, wherein the secondary inputs comprise eating habits of a user.

16. The non-transitory computer readable medium of claim 10, wherein the secondary inputs comprise a previous inventory from before the measurement data was received.

17. A method for maintaining an inventory of items within a storage unit, the method comprising:
determining, using measurement data from a plurality of load cells in the storage unit, a current measured state of the storage unit comprising: a first location and a first weight associated with a first item, and a second location and a second weight associated with a second item;
receiving secondary inputs, wherein the secondary inputs are different from the measurement data; and
identifying a current inventory arrangement comprising the first item and the second food item by:
comparing the current measured state of the storage unit to a previous measured state of the storage unit to yield a plurality of potential inventory arrangements;
performing a regression analysis to reduce the plurality of potential inventory arrangements, wherein the regression analysis is based on the secondary inputs, the first location, the first weight, the second location, and the second weight, wherein the current inventory arrangement is an output of the regression analysis when the regression analysis reduces the plurality of potential inventory arrangements to one; and
receiving user feedback when the regression analysis reduces the plurality of potential inventory arrangements to more than one, wherein the user feedback indicates which potential inventory arrangements of the plurality of potential inventory arrangements is the correct inventory arrangement.

18. The method of claim 17, wherein the user feedback is used for a future regression analysis.

19. The method of claim 17, wherein secondary inputs comprise object data, season data, time of day, previous inventory state, and user habits.

20. The method of claim 17, further comprising identifying an inventory change event by determining if a derivative of the measurement data exceeds a target threshold.
